(19) United States
(12) Patent Application Publication
(10) Pub. No.: US 2009/0017794 A1
(43) Pub. Date: Jan. 15, 2009

(54) TELECOMMUNICATIONS SERVICES APPARATUS AND METHODS

(75) Inventor: Jeffrey Wilson, Hampshire (GB)

Correspondence Address: RENNER OTTO BOISSELLE & SKLAR, LLP, 1621 EUCLID AVENUE, NINETEENTH FLOOR, CLEVELAND, OH, 44115, US

(73) Assignee: INTELLPROP LIMITED, Guernsey (GB)

(21) Appl. No.: 10/595,953

(22) PCT Filed: Nov. 22, 2004
(86) PCT No.: PCT/GB2004/004922

§ 371 Date: Jul. 25, 2007

(30) Foreign Application Priority Data
Nov. 21, 2003 (GB) 0327137.6
Nov. 25, 2003 (GB) 0327372.9
Dec. 10, 2003 (GB) 0328606.9
Dec. 12, 2003 (GB) 0328858.6
Dec. 16, 2003 (GB) 0329108.5
Dec. 18, 2003 (GB) 0329316.4

(51) Int. Cl. H04M 3/42; H04Q 7/38

(52) U.S. Cl. 455/414.1; 379/216.01

(57) ABSTRACT

Telecommunications services apparatus includes means for establishing a connection from a mobile terminal in response to alphanumeric dialling on the terminal, such that alphanumeric dialling information is transmitted from the terminal to the apparatus.

This invention relates to telecommunications services apparatus and methods, such as for use with a mobile telecommunications system, such as a mobile telephone system. Users of mobile telephones can directly call other users of telephones, and can also have access to a variety of voice services, including network-based services such as voicemail and also information and entertainment services such as live radio feeds. Some types of mobile phone, particularly those known as third generation, or 3 G, can make audiovisual connections and access a wide range of media. However in all these cases they must know the number to dial.

Normally, a user originates a call to a voice service or an organisation by dialling a string of digits representing the telephone number of the desired destination. Most people have difficulty memorising more than a few telephone numbers and therefore use various forms of directory to provide a translation from meaningful alphanumeric name to digit string.

In the case of mobile telephone users, the directory or ‘phonebook’ contained within the handset is very useful. However if a service or other destination is called infrequently the user may not have stored the number, either because of capacity limitations or because future use was not foreseen. Later, when the call is required, obtaining the number from other sources may be difficult, especially if the user is away from home or office.

It is normally possible to store a single number that can access a service or destination from any country. For example, (unlike a call from the fixed network) +44 1489 885877 will reach the required destination whether the call is made from within the UK or overseas. However should the number change, e.g. through a national code change, then the user will have to edit the mobile handset phonebook entry.

Some attempts to overcome the problem of making telephone numbers known to potential callers have been made with personal numbers and particularly Freephone numbers. For example, generic identifiers in the UK such as 0800 FLOWERS may be used to route calls to a specific florist, or (with Intelligent Network number translation facilities) to the florist nearest to the caller. Specific identifiers, such as 0800 TELSIS, can be dialled to reach a particular company or organisation.

In another branch of communications, a similar problem of using long digit strings to identify Internet websites has been very effectively overcome by allowing users to enter alphanumeric addresses (domain names) of the form ‘www.companyname.com’ as an identifier of a desired destination. Such addresses are translated within the Internet network to the required numeric strings. Furthermore, Internet search engines are available so that when a user cannot remember or does not know the required domain name, an approximation or keyword can be entered to enable intelligent identification of potentially desired websites, which is done by providing a list of possible sites.

PCT-WO 01/08430 discloses that alphanumeric entry on the user's handset using a text message can cause the return of a number to the handset, a process known as ‘Directory Enquiry’. The mobile phone user can then call a selected number, either by keying in the number again or by using the ‘Use Number’ facility available in some handsets, which enables extraction of numbers from SMS messages for immediate use in dialling. This method requires the user to perform two separate steps, first to send a text message to a well-known service number, and then to make a voice call to a (different) received directory number. The same prior art document discloses two further approaches. Either the call can be automatically completed by outdial from the network (‘outdial method’) on receipt of the text message, or alternatively a handset improvement would permit automatic call set-up from the handset (‘indial method’) on receipt of the response.

PCT/GB2004/002058 describes alpha name servers used to provide the translation between alpha strings and network addresses in much the same way as Domain Name Servers provide IP addresses from Internet URLs.

Samuel Johnson (1707-1784) is quoted as saying “If it rained knowledge, I'd hold out my hand; but I would not give myself the trouble to go in quest of it.” This aptly illustrates the present situation with regard to connectivity between a mobile telephone and the very large number of potential audio sources, audio services, chat-lines, bulletin boards, organisations, product promotions etc. and other voice services and/or voice connections to which a mobile telephone user would like to connect—if it were easily possible to do so.

At the moment if a mobile telephone user wants to listen to a particular radio station, take part in a particular chat service or contact a particular voice or video bulletin board, the user must know the specific service number, which in itself, for regulatory, technical or commercial reasons, may change from time to time.

At the moment there is no way for a network operator to easily discover what services or what connections its users would like. At the same time there is no technical means to create new services immediately, i.e. at the instant of request, so that a user is connected as though the service had already existed.

In the case of connection to a service whose current existence is unknown, perhaps a specific chat or bulletin board service, there is currently no easy way for a mobile phone user to connect to such a service as there is no easy way to find out its existence. In the prior art there is no currently used technique that can allow a caller to dynamically create a required service and this point is important because it illustrates the difference between a number-based system such as the ITU E.164 standard and one that could provide connectivity to services for which there is no number per se. When start-at-the-beginning premium rate voice services were first introduced in Europe, the main commercial constraints on such services quickly became apparent. There were three related constraints—
Firstly, the service provider had to pre-decide what services to offer;
Secondly, the service provider has to associate a telephone number with each service;
Thirdly and most importantly, it was very expensive (and ongoing expense was required) to promote the services and numbers to potential callers.

Promoting unique telephone numbers for each and every service is expensive because of the enormous diversity of possible services and associated telephone numbers. This approach also places a high cognitive load onto users. For example, when a Radio Station announces details of a competition or promotion that may be attractive to a particular listener, that listener must not only absorb the pertinent details of the promotion, but must also memorise or record a telephone number. The cognitive load of dealing with the telephone number detracts from the rest of the promotional material, and furthermore if the user is busy or driving, recording a telephone number may be impractical.

Drawbacks of the ‘0800 TELSIS’ approach to making numbers easier to remember include the fact that a number of different layouts for letters on telephone keypads are in use throughout the world, and also the fact that multiple alphanumeric strings can share the same numeric representation. Whilst the problem of keypad variations has been eased in recent times with the introduction of an ISO standard, organisations may still have to promote both alpha and numeric telephone numbers, e.g. ‘0800 TELSIS (835747)’.

In addition, callers who are not in the ‘home’ country may have difficulty in accessing such numbers. For example, somebody in the Netherlands wishing to call Telsis in the UK would normally have to dial the international access code, followed by the country code and then the UK telephone number (without the leading zero), i.e. 0044 800 TELSIS. This means that the caller would have to know where Telsis is located and the appropriate country code and number format. Even if these are known, access is unlikely to be permitted because 0800 is a Freephone code and, even where networks allow it, the organisation may not wish to accept the charges resulting from international calls. An attempt to overcome these difficulties and restrictions has been made through introduction of the Universal Freephone service in which a logical country code of 800 has been allocated. Thus dialling 00 800 00 TELSIS could allow access to Telsis from any country supporting the Universal Freephone service, but in practice the organisation has to arrange for the particular Universal Freephone number to be activated in every country from which it is prepared to accept calls.

A further limitation of the technique of WO 01/08430 is that text sent to the network for the purpose of specifying a destination to dial is interpreted literally by the network, e.g. by being looked up in a database or table and converted to a telephone number. This approach is very restrictive in that it requires an exact match between the text entered and the database entry. Multiple database entries are required in the prior art if the system is to cope with the many common variations of requested destinations. For example the user who has lost his credit card may wish to urgently call the Lost Card department of Barclaycard (RTM). Although provision of alphanumeric dialling capability would remove the need for the user to know or find the necessary telephone number, there are many possible forms of destination name that a user might compose, such as ‘Barclaycard’ ‘Lost Barclaycard’ ‘Barclaycard lost card’ ‘Barclaycard stolen card’ etc. Without an intelligent text processing engine, the task of dealing with a wide range of possible user input becomes impractical, and systems relying on a simple lookup table approach are doomed to provide inflexible and poor service. In the prior art, no indirection or intelligence is interposed between the text entered by the user and the lookup step.

Another limitation of the technique of WO 01/08430 is that text messaging in traditional networks is subject to variable delays, particularly in the transit time through an SMS Service Centre (SMSC). At busy times messages can be delayed for minutes or hours. This could result in unacceptable delays for the user trying to set up a voice call, and in the case of the network outdial method, would increase the window where an unexpected call could arrive between the sending of the text message and the outdial from the network to the user, leading to possible confusion. It must be emphasised that any system that can subject the call set-up process to a variable and indeterminate delay will be frustrating for the users. It is therefore a highly undesirable that an SMSC be included in any call set-up path.

It is also known to use WAP as a means to select an alphanumeric string as a specifier of a desired destination telephone call. There is little support in current networks or handsets for WAP over SMS transport, while there is widespread support for WAP over a GSM traffic channel, which requires the set-up of a GSM data call prior to sending a request. The delay in setting up a GSM data call can be as much as 30 seconds, which makes this approach impractical for requesting connection by a subsequent voice call.

Current limitations of international call handling mean that for voice calls dialled by a subscriber, the subscriber's CLI is often not delivered to a destination. This can restrict access to certain services and destinations. In contrast, outdial by the network to the subscriber provides a ubiquitous means for setting up voice calls without problems of CLI and without regard to the customer's location.

According to one aspect of the invention there is provided telecommunications services apparatus for use with a mobile telephone network, the apparatus comprising means for establishing a connection from a mobile terminal in response to alphanumeric dialling on the mobile terminal, wherein alphanumeric dialling information is transmitted from the mobile terminal to the connection establishing means.

According to another aspect of the invention there is provided apparatus for establishing a connection from a mobile telephone handset using alphanumeric dialling.

According to a further aspect of the invention there is provided a method of establishing a connection from a mobile telephone handset using alphanumeric dialling.

According to a still further aspect of the invention there is provided a telecommunications services method for use with a mobile telephone network, the method comprising establishing a connection from a mobile terminal in response to alphanumeric dialling on the mobile terminal, wherein alphanumeric dialling information is transmitted from the mobile terminal to the connection establishing means.

Other aspects of the invention provide a computer program for implementing a method as set out above and a storage medium storing the computer program.

According to the invention there is further provided a telecommunications services apparatus for use with a mobile radio telecommunications system to which is connected at least one mobile terminal capable of at least voice and text communication, said apparatus comprising a text message decoder for receiving a text message from a mobile station of the mobile radio telecommunications system, and for identifying the received text message as a request for connection, and means for using the received text to determine a first connection associated with the received text message; and a connecting means for setting up a second connection to the mobile station that initiated the text message, and for setting up said first connection and for connecting said second connection to said first connection.

The terms first and second are used for distinguishing two connections and do not imply any sequence.

The second connection, to the mobile terminal, may be set up in a number of ways. This could be a voice call, or on capable terminals could be a multimedia or audiovisual call.

Alternatively the connection could be made by other means, for example via a data connection that provides suitable connectivity such as can be provided by GPRS or a 3 G technology The term text message is to be interpreted as any means for transmitting to the network a representation of an alphanumeric entry made by the user. For example this includes but is not limited to
a Short Message of the GSM SMS service and enhancements thereof such as EMS and MMS, and their equivalents in a non-GSM network
an Unstructured Supplementary Service Data (USSD) message
a message transmitted over a packet data bearer such as GPRS

According to a further aspect of the invention there is provided a telecommunications services apparatus for use with a mobile radio telecommunications system to which is connected at least one mobile terminal capable of at least voice and text communication, said apparatus comprising a text message decoder for receiving a text message from a mobile station of the mobile radio telecommunications system, and for identifying the received text message as a request for connection, the decoder being operable to process the text message to derive an alphanumeric string which may be different from the received text, and means for using said derived string to determine a first connection associated with the received text message; and a connecting means for setting up a second connection to the mobile station that initiated the text message, and for setting up said first connection and for connecting said second connection to said first connection.

According to the invention there is further provided a telecommunications services apparatus for use with a mobile radio telecommunications system to which is connected at least one mobile terminal capable of at least voice and text communication, said apparatus comprising a text message decoder for receiving a text message from a mobile station of the mobile radio telecommunications system, and for identifying the received text message as a request to define a connection, and means for using the received text to determine a first connection associated with the received text message; and a connection means for receiving a second connection from said mobile terminal and for setting up said first connection and for connecting the received second connection from the mobile station to said first connection.

According to the invention there is further provided a telecommunications services apparatus for use with a mobile radio telecommunications system to which is connected at least one mobile terminal capable of at least voice and text communication, said apparatus comprising a text message decoder for receiving a text message from a mobile station of the mobile radio telecommunications system, and for identifying the received text message as a request to define a connection, the decoder being operable to process the text message to derive an alphanumeric string which may be different from the received text, and means for using said derived string to determine a first connection associated with the received text message; and a connection means for receiving a second connection from said mobile terminal and for setting up said first connection and for connecting the received second connection from the mobile station to said first connection.

According to a further aspect of the invention, the said text message comprises a Short Message of the GSM Short Messages Services.

According to a further aspect of the invention, the said text message comprises an Unstructured Supplementary Service Data (USSD) message.

According to a further aspect of the invention, the said text message is delivered to the apparatus using groomed means or direct delivery means preferably by means of an SMS Router, thereby avoiding SMSC delays.

According to the invention, said connection means also sends an identification signal characteristic of the telephone number of the originating mobile station to the requested connection.

According to a further aspect of the invention, a connection identity is announced to the caller before connection. This provides feedback to the caller regarding any translation that may have taken place between the text entered and the connection determined by the apparatus.

According to a further aspect of the invention, a price announcement is made to the caller indicating charges that may apply to the connection determined by the apparatus.

According to a further aspect of the invention, a user that Text Dials an email address, i.e. sends a text message containing an email address to a service number, is connected to a recording service which is operable to deliver a recorded voice message to the specified email address.

The invention will now be described by way of example with reference to the accompanying drawings, throughout which like parts are referred to by like references, and in which:

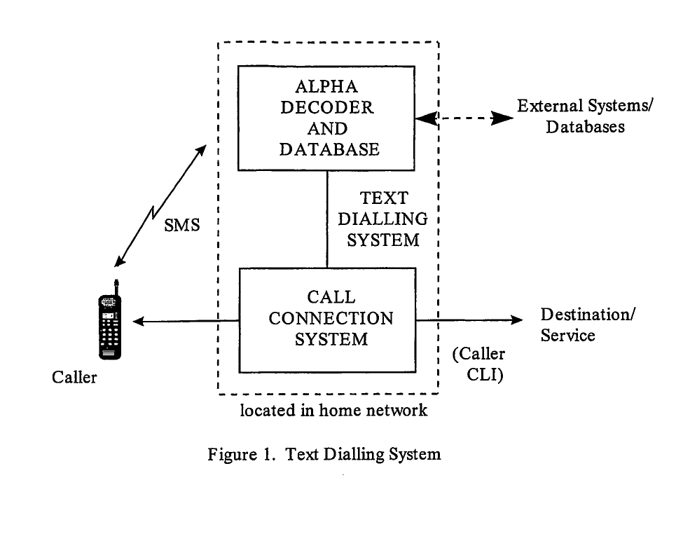

FIG. 1 is a block diagram of a telecommunications services apparatus in accordance with an embodiment of the invention, comprising a Text Dialling system;

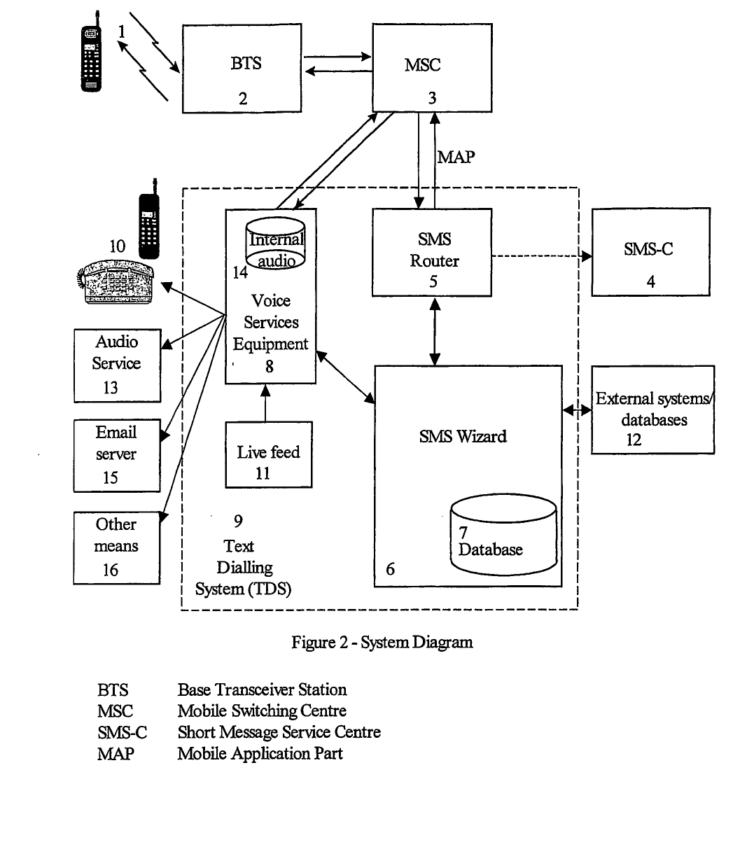

FIG. 2 is a block diagram showing a network configuration of the dialling system; and

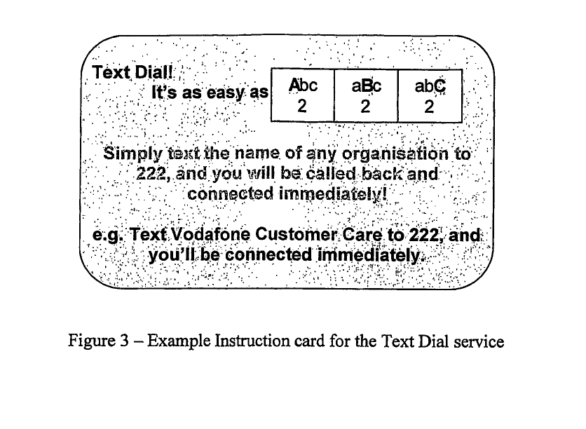

FIG. 3 is a diagram showing an example instruction card for the service.

Referring to FIG. 1, there is shown a Text Dialling system comprising a call connection system CCS and an alpha dialling decoder and database ADDD. The call connection system provides communication with a mobile station (caller) MS, and connection to a desired destination or service.

FIG. 2 shows a mobile station MS (1) communicating with a network comprising a base transceiver station BTS (2), a mobile switching centre MSC (3), SMS Router (5) and a short message service centre SMS-C (4). In a preferred embodiment, Text Dialling messages are sent using SMS but do not pass through the SMS-C (4). The MSC (3) communicates via the Mobile Application Part protocol MAP with a Text Dialling system (9) embodying the invention. The Text Dialling system (9) includes a SMS Router (5) through which some or all Mobile Originated SMS messages in this network preferably pass, an SMS Wizard engine (6) for intelligently processing the entered text, a database (7) containing rules, exceptions and knowledge tables for the SMS Wizard (6) and a Voice Services or Switching equipment (8). The Voice Switching equipment (8) provides communication to a selected internal connection such as a live feed (11), stored audio/text to speech (14) or other service, or to an external connection, telephone (10), audio service (13) or email server (15), or via other means (16). The SMS Wizard (6) may be connected to external systems and/or databases (12) such as an external alpha name server, or hierarchy of such servers. In alternative embodiments, the Voice Switching equipment (8) may comprise audiovisual switching equipment. The SMS Router (5) may be, for example, one manufactured by Telsis Limited.

Embodiments of the invention remove a key constraint on voice and audiovisual telephony, which is that people currently have to obtain and dial telephone numbers in order to connect.

It is much more useful to access services using text (“Text Dialling”) as names are stable for long periods and are so easily remembered that there is no need for pre-planning of phone book entries.

So for example if one could directly Text Dial—
Radio 4
or Manchester United Chat
or Vodafone Customer care
   then connection is easy for the mobile handset user, and because callers could now connect easily it would be worthwhile for other parties to provide useful connections. Further examples of the types of connectivity that would be useful to mobile telephone users are now given in order to illustrate an embodiment of the invention. The Text Dial column shows the text entered/dialled in order to achieve the desired connectivity and the Benefit column provides an explanation of the benefit of Text Dialling.

| Text Dial | Benefit |
|---|---|
| Vodafone | Wherever and whenever, one could contact a |
| Customer Care | customer-care service without any need to remember |
| | a number |
| Metro Radio | One can gain immediate access to any radio station |
| | live-feed offered by the network provider; all the user |
| | needs to know is the station name. This is useful in |
| | many cases for listening to live commentary of home |
| | football games. (Note: Metro Radio is the |
| | independent radio station for Tyneside in the UK, |
| | home of the Newcastle United football team.) |
| PowerFM | Text Dialling allows radio stations to promote easily |
| Romance | memorable promotions - as in this example, which |
| | could be for a dedication service on Valentine's day. |
| | All that the radio station has to do is advise listeners |
| | to Text Dial “PowerFM Romance.” It's now much |
| | easier to promote a wide range of services and much, |
| | much easier for listeners to connect to them, as |
| | compared with the current situation where listeners |
| | have to remember unique telephone numbers. (Note: |
| | PowerFM is an independent radio station for Central |
| | South Hampshire in the UK.) |
| News | One can access start-at the beginning News provided |
| | by the network provider without ever having to worry |
| | whether such a service is available or what number to |
| | use. |
| BBC News | One can access branded News |
| ITN News | One can access branded News |
| Bloomberg | One can access branded/specific News |
| Business News | One can access specific News |
| L'Oreal hair care | L'Oreal can now easily provide proprietary hair care |
| | information to its customers, and unlike a number |
| | based service there is no difficult-to-remember |
| | number and reinforcement of the service can be |
| | achieve by repetition of the phrase alone. |
| Clarins | Clarins can now ensure that it's very, very easy for |
| or Clarins news | women to get information on Clarins products. As |
| | there is no number involved, there is no need to |
| | remember a number and hence no barrier to use - to |
| | the benefit of Clarins and its customers. |
| Frosties Florida | A breakfast cereal product can promote a competition |
| competition | where the name of the promotion is the means to |
| | access the promotion - resulting in a better-focussed, |
| | more cost-effective promotion. (Note: Frosties is |
| | brand of UK breakfast cereal) |
| Shake Me | This is perhaps the easiest example to understand in |
| | terms of the invention. The strap-line for the |
| | ‘Orangina’ drink is (in English) “Shake Me.” To run |
| | a customer promotion before this invention it would |
| | be necessary to promote a number on television |
| | and/or radio and/or publications and/or the product. |
| | However the invention allows customers to connect |
| | directly to the promotion without requiring a number |
| | to be involved - all the customer needs to do is to |
| | remember the single phrase “Shake Me”, which can |
| | be easily promoted, for example on the radio. |
| Pompey chat | Chat lines can now be provided with no requirement |
| | to promote a number - and even more powerfully, |
| | Text Dialling allows a chat line service to be |
| | allocated dynamically so that for example the |
| | Pompey Chat service would start up when the first |
| | caller Text Dialled it. (Note: Pompey is the colloquial |
| | name for the football club of Portsmouth in the UK.) |
| Man U messages | Bulletin Board services can now be provided with no |
| | requirement to promote a number - and services can |
| | also be created and managed dynamically, providing |
| | economic benefits to network operators and |
| | improved service to callers given the almost |
| | unlimited number of bulletin boards that can be |
| | offered. A bulletin board can be automatically |
| | created on first use. |
| Kylie | The world of celebrity is very important to many |
| | people and an easy and memorable way to get up to |
| | date information on a celebrity in a warm, emotional |
| | way (i.e. by voice) provides great utility. It is also of |
| | benefit to the celebrity to support such services. |
| George Clooney | Another celebrity for ER fans! |
| Terminator 3 | Many of today's products such as films, are heavily |
| | branded and an easy and memorable way to get up- |
| | to-date information on them is highly desirable for |
| | potential cinema goers (in the case of films) and is a |
| | very attractive proposition for a film's promoters. |
| another@telsis.- | Sometimes the only contact details for a person or an |
| com | organisation are an email address and yet one would |
| | like to simply leave them a voice message. A Text |
| | Dialling system can be configured to connect the |
| | caller to a voice email system that will record a voice |
| | message and then forward it as a voice attachment to |
| | the email address. |
| NHS Direct | Many Services or Organisations have well known |
| | names, but the associated number may not be |
| | available when contact is required. Text Dialling |
| | provides immediate connectivity. |
| Barclaycard | In emergency situations it is important to establish |
| lost card | contact immediately. Text Dialling allows a caller to |
| | use most meaningfiul text inputs in order to establish |
| | the required connectivity. |
| RAC breakdown | In emergency situations, the ability to immediately |
| | Text Dial ensures that there are no problems in |
| | establishing the required contact. |
| 0797835225 | Text Dialling can also be configured to provide direct |
| Voice Mail | connection to a telephone's Voice mail box so that a |
| | message can be left for later retrieval (and if required, |
| | repeated retrieval.) |

In February 2004 it is anticipated that there will be 1 billion GSM handsets in use and that almost all, if not all, of these handsets will be capable of voice calls and text messaging. Also, many mobile terminals will be a capable of audiovisual communication.

Although the ability to dial by entering text can be seen to be if great utility, if the only way to introduce such a service was to replace all handsets as well as upgrading all networks then the current economic benefit of Text Dialling would be significantly reduced.

Embodiments of this invention provide for Text Dialling using standard GSM Handsets and use a simple architecture to achieve it so that a GSM network can quickly add Text Dialling capability. Embodiments of this invention are also applicable to other types of mobile technology, including but not limited to TDMA, CDMA and 3 G.

In addition as a further development of the invention, the adoption of a Text Dial code (preferably 222) as a standard, would allow other modes of operation to the preferred implementation described here. New mobile handsets could also have Text Dialling built in so that an even simpler man-machine interface is possible.

For the first time, the technologies of Text Messaging for rapid alpha entry, SMS Routers for rapid delivery without variable delays, SMS Wizard for intelligent processing and interpretation of text, Alpha name servers for managed translation of alpha names into connections and Voice or Video Switching Equipments for connecting the caller to the requested name have been brought together to enable a facility known as Text Dialling, which permits any mobile phone user, with at least the basic call features of voice and text, to be connected to any organisation, company, brand, chat room, celebrity message, local service, live audio feed, voice mailbox etc. . . . the list is endless. The step change in connectivity provided by this invention cannot be underestimated as it allows names to be used that users already know. The connection may be made by a variety of methods such including but not limited to—
Circuit switched voice call
Packet switched voice call
Direct connection internal to the Voice or Video Switching Equipment
TCP/IP
ATM
Audiovisual connection

The present technique utilises a ‘Text Dialling’ system, which is operable using an unmodified basic handset that needs only to support voice calls and text message sending. As such the technique is applicable immediately to the vast majority of the mobile telephone handsets in use, and to many fixed line terminals. This technique is also applicable to fixed network terminals that support voice and text sending. Further aspects of the technique ensure that the text message is delivered rapidly to the apparatus to enable rapid and predictable call-set-up performance, without the variable delays introduced by traditional SMS network architectures. The technique is also applicable to mobile terminals with enhanced capabilities, and will be particularly useful with 3 G video handsets, allowing the possibility of browsing audiovisual content without any need to find telephone numbers.

In a preferred embodiment, the mobile user composes an SMS text message that comprises an identifier for the required destination party, service or category of services. The message is sent to a service number via the mobile telephone network to the ADDD. Preferably the SMS text message is routed via an SMS Router rather than through an SMSC using a technique known as grooming or direct delivery. This removes temporal ambiguity from the call set-up process and provides predictable call set-up performance. The ADDD system performs processing on the entered text using an SMS Wizard that is part of the ADDD and derives a preferred form of the requested destination. The apparatus then performs a database look-up using the preferred form to identify a requested connection that corresponds to the text identifier. In the case of a category of services, sponsored telephone numbers may be provided as the preferred connection translations, allowing the directory system to provide a commercial income.

In an alternative embodiment the system may be operable to use the entered text directly without translation by an SMS Wizard.

Preferably the text message decoder is in the form of an SMS Wizard, such as is described in EP-A-1 185 119. This is operable to intelligently process received text using a system of exceptions, classes and rules to derive an alphanumeric string from the input text supplied by the user. The processing is able to cope with multiple forms and spellings of names, different short-forms and arbitrary punctuation. Preferably the derived string determines the audio that is played to the user for confirmation before the user is connected. For example, if the user enters ‘Virgin Airline’, the SMS Wizard (6) is able to interpret this as a request for connection to a number for Virgin Atlantic, and announces for example: “connecting to Virgin Atlantic.” Variations such as Airways or Airlines are provided for in the SMS Wizard's text processing, and the preferred or correct form is the one derived.

Optionally the system may offer choices to the user if the SMS Wizard (6) is not able to determine a resolution of the entered text. The choices may be offered as an audio menu when the voice call is connected, or may be sent in a text message or by other means.

The derived string is passed to a lookup process, preferably implemented as an external Alpha Name server that is analogous to the Domain Name server in TCP/IP networks. The Alpha Name server is preferably centrally maintained, although its implementation may be distributed. The name entries in the alpha name server are in the same form as the derived strings in the SMS Wizard, and are used by the system to initiate connections.

Preferably the Alpha Name server is a managed resource, which means that the entries and translations that it makes are managed and controlled. In contrast, the prior art describes databases where users can add their own aliases in a free-for-all fashion as is common on web email systems. This leads to an anarchic and un-organised naming scheme, where generally the contact-name of any subscriber cannot be guessed. This is the exact opposite of the intent of the present invention where it is desired that connectivity should be enhanced because people are able to Text Dial names that they already know.

Preferably the apparatus is arranged to commence outdial first from the Voice Switching equipment (8) to the mobile station that initiated the text message, and on answer to effect the requested connection associated with the received text message, although alternative sequencing of operations is possible.

Preferably the CLI of an outdialled call to the originator of the text message is the same as the service number to which the text message is sent, allowing the user to easily recognise the call as being the one initiated by the text message, rather than a different call. Preferably the CLI of the originator is passed to the requested connection.

The outdial to the mobile station that initiated the text message is preferably prevented from going to Voice mail or to another diverted number as this would cause unexpected and undesirable behaviour. For example, if this were not prevented, a voice mail system could become connected to the destination number that the user requested. This situation may be avoided by outdialling with call parameters set to prevent diverts. Alternatively, diversion may be detected by the apparatus and the call set-up immediately terminated, in which case the apparatus preferably notifies the originator by SMS. If the call back to the originator does not result in answer, then connection to the requested destination is not initiated. The apparatus may employ a retry algorithm that attempts to connect to the user again in the event that the call back fails.

The ‘outdial’ method described above may be preferable to an alternative ‘indial’ method that is now described. Outdial may be preferable because it can work while the user is roaming, without any requirement for the roaming network to support CAMEL or other special facilities. Text Dialling requests sent by SMS are automatically routed back to the home network using the global title of the home network's SMS Service Centre that is programmed into the handset. Similarly if USSD is used as the transport for the text request, certain ranges of USSD command codes are specified as being transported transparently to the home network. When the apparatus outdials to the user, it does not matter where the user is located or whether he is roaming, since mobile networks are designed to route voice calls correctly. Therefore the Text Dialling user is able to receive a call-back and to be connected to a destination regardless of where he is roaming.

In an ‘indial’ implementation, optionally the service number used for the text message and the service number used for the voice call are the same service number. Preferably an international standard is adopted whereby a preferred short service number is operable to connect the caller to apparatus in his home network to facilitate Text Dialling while roaming. Alternatively, a service number in international format may be used for the indialled call, thereby overcoming the limitations of dialling from a roaming network.

Preferably the first acknowledgement of the text message delivery received at the handset is indicative that the apparatus has received and processed the message and is ready to accept a voice call and effect the requested connection associated with the received text message.

Whether an outdial or indial method is used, the text message decoder may include a database linking alphanumeric identifiers with respective connections. Means may be provided for accessing at least one external database linking further text identifiers with respective further connections.

The apparatus optionally retains memory of the requested connection last used so that further calls or reconnections may be made without re-entry of the alphanumeric text message. The memory data associating a CLI with a previously used connection may be stored in a network data store or in a data store or table within or associated with the apparatus. The use of memory in this way is particularly applicable to ‘outdial’ implementations of the invention where the apparatus dials back to the originator. Indial implementations may also use memory, but care must be taken to avoid a race condition between a text message from a user specifying a desired connection and a voice call from the same user with intent to connect to the specified connection. If the voice call arrives and is processed before the text message has been processed to determine a connection, then there is a possible ambiguity in whether the system should wait, or use a previous connection identity stored in memory. In a preferred implementation, return of a ‘message sent’ type of acknowledgement to the user is indicative that text processing is completed and that a subsequent voice call will invoke the most recently requested connection.

A preferred implementation of the invention is also operable, subsequent to a drop in the connection, to accept a voice call addressed to the said service number as a request to reconnect.

In a commercial implementation of Text Dialling, it is envisaged that an outdial implementation could advantageously be launched first, since this mode of operation requires the least customer familiarisation and is therefore more easily adopted. The users simply send a text message to a short code and they are called back and connected. This process only requires one action on the part of the user, which is sending a text message. However there are billing issues as described below.

An advantageous second phase of implementation could offer an indial version of the service. An indial implementation of Text Dialling as described herein provides a number of advantages:
No billing changes whatsoever are required in the network, since the only operations carried out by users are the sending of text messages and the initiation of voice calls. Both of these operations are already covered by existing billing systems.
Call set-up can be faster, since at least part of the text message transmission and processing time can take place in parallel with call set-up time for the indialled call.

In an embodiment of the invention, the user sends a text message to a short code, preferably by sending a GSM Short Message, and preferably to the destination number 222, to specify a desired connection, and subsequently makes an indialled call to the apparatus. There are a number of options for how the indialled call could be initiated.
1. The user could dial a short code. In this case the short code dialled would preferably be 222 as this is the same as the preferred short code destination for the text message. The network would be configured to route calls to this short code to the apparatus. A disadvantage of this method is that it does not always work for roamers as the roaming network may interpret short code numbers differently from the home network.
2. The user could dial a long number in international format to set up a call to the apparatus. The network would be configured to route calls to this number to the apparatus. This will work in all cases even when the user is roaming, since the international prefix and network code will route the call to the home network.

To make the dialling process easier for the user, the long number could be assigned to a ‘speed-dial’ key on his handset. In this way, once the number is programmed into the handset, the user no longer has to remember the number. Alternatively, the number could be programmed into the handset's phone book, for recall when required.

A key advantage of the indial method of operating a Text Dialling service, over an outdial implementation, is that the indial method required no billing changes whatsoever to the network. In contrast an outdial method may require a means for charging the called user for the call leg between the user's terminal and the apparatus. For example, if the user is roaming the outdialled call leg will usually involve an international call, which may need to be charged. The charge may either be borne by the user, a situation known as reverse billing, or may be charged to a third party, as for example in the case of a Freephone service. Reverse billing can take some time for a network operator to implement and test. For minimum time-to-market, an indial-based implementation may therefore be preferable. A key goal of the present technique is to make the user experience as simple as possible to encourage adoption of the service. So-called ‘Speed-dial’ functionality is commonly available on mobile handsets, and allows a simple key operation, for example a short sequence of keys or a long press on a single key, to activate a pre-stored dialling function. Typically, the speed-dialling function of a handset may be disabled, and is often disabled by default when a new handset is supplied. Disabling speed-dialling prevents inadvertent dialling of numbers if keys are pressed accidentally. Alternatively, if a user wishes to enable speed dialling, a keypad lock may be activated when the handset is not in use to prevent inadvertent dialling of numbers.

On some handsets, a key such as the digit ‘1’ key, is reserved for speed dialling the user's Voice mail. The voice mailbox access number is usually programmed into the handset to enable this feature, which is often operable whether or not speed dialling is enabled for the other keys. By substituting an access number for Text Dialling for the voice mailbox number programmed into the handset, easy dialling of the Text Dial apparatus may be achieved. Alternatively, if it is not desirable to remove the speed dialling of Voice mail, an alternative key may be substituted. Preferably the access number for Text Dialling may be assigned to digit key ‘2’. Speed dialling would need to be enabled on a standard handset for this to be operable. In this case an optional variant would preferably send the text message to 2 (as opposed to a short code such as 222) so that the user experience was more clearly defined i.e. the same key for text and voice.

All of the methods described here for implementing indial-based Text Dialling are operable on unmodified mobile handsets, on a mobile network with an unmodified billing system.

The technique is operable to provide the caller with a wide variety of connections including but not limited to—
Start-at-the-beginning audio sources
Live feed audio sources
Celebrity news
Product promotions
Chat services
Destinations that do not have a telephone number, but may nevertheless be routed to, for example over an IP data network
Voice mail systems
Paging or messaging systems
email
Agents or operators
Other telephones fixed or mobile
Any other type of telephony service

Clearly, if the mobile terminal has enhanced capabilities, such as for example audiovisual communication, then the scope of possible connections is increased. In the case of audiovisual capability this would allow access to video live feeds, video bulletin boards, video news clips and the like.

It should be noted that these destinations do not necessarily have a telephone number, and in some cases the apparatus is operable to connect to a destination that does not have a diallable number in the normal sense. For example direct connection to a voice mailbox max be achieved using the technique provided network signalling permits it, yet the voice mailbox may not be diallable directly by a subscriber, or have its own telephone number. Thus the connection resolved by the apparatus may be a routing specified in other ways than a telephone number.

The connection may be to a resource within the Voice or Video Switching apparatus, for example utilising stored content. The connection may be to a conference or chat system. If the Voice or Video Switching equipment is distributed across several devices in a network as would be desirable for geographic redundancy, then it may also be desirable to implement a centralised control function, such as a Service Control Point, to manage some types of service.

A further example is provided by connection to email. In a preferred embodiment, a user that Text Dials an email address, i.e. sends a text message containing an email address to a service number, is connected to a recording service which is operable to deliver a recorded voice message to the specified email address.

The SMS Wizard (6) preferably retains memory, on a per CLI basis, of the last connection used by each user. In a national implementation, subsequent voice calls sent to a service number may automatically use the last connection without recourse to further lookup. Internationally this may not be effective, because short codes may have a different effect when dialled on a roaming network. However commercial adoption of this technique may preferably result in the specification of an internationally agreed short code, such as 222.

Preferably the system provides an audio announcement to one or both ends, to indicate to the caller exactly what connection has been reached, and in certain cases to a recipient to indicate or advertise the connecting service. The audio announcements may comprise stored audio, text-to-speech generated audio, or a combination of the two.

The system may, in conjunction with the alpha name server, employ a location-based mechanism that uses the location of the caller, and in certain cases the location of the called party or both locations, and may direct the choice of translation between user-entered text and the connection that is required. Furthermore the alpha name server may carry pricing information for connections, and announce this to the caller prior to connection. This allows the technique to be used with a range of tariffs including but not limited to Freephone and premium rate.

Alternative embodiments of the alpha name server may also support VPN functionality, where certain translations between names and numbers are personalised or restricted to a particular user or closed group of users. Commonly in such cases short-form dialling is possible.

A key advantage of the present invention is that it allows a user to initiate a call to an organisation, brand, service, chat room, bulletin board etc. by simply using the name and a well-known service number, which may preferably be a short code such as 222. The technique may be readily implemented to work immediately with unmodified GSM handsets. The text transport can use SMS, which is supported in all modern and most legacy GSM handsets, while the voice call connection may use outdial from the network, which also does not require any special handset capabilities. Similar alternative technologies may be used on other types of network.

The invention works identically even while the user is roaming, provided the outdial method is used or the indial method is used with an international format number, without any need for Camel support or special USSD applications. This technique is to voice telephony as the Browser is to the Internet. It opens up connectivity between users to a vast range of organisations and content sources, without requiring the advertising or distribution or any numbers.

The technique may be used with multiple directories. For example a hierarchy of directory searching may be provided, or alternatively different service codes could be used to specify—
The user's personal directory
A local directory
A national directory
An international directory

In a further embodiment of the invention, the user is also able to send a text message to the service number as an alternative to making a voice call. To achieve this, a syntactic rule is preferably applied to the text message content. In a preferred embodiment, the destination address specifier and the message are both included in the body of the text message, separate by ‘ . . . ’ as a delimiter. The message is then sent to 222, which is the preferred service code for embodiments of the invention. (This service code has been chosen because it is easy to remember, and corresponds to the number keys for ‘ABC’, so that the Text Dialling service can be promoted as being ‘as easy as ABC!’) The delimiter ‘ . . . ’ has also been chosen because of its association with continuation. Text message in the preferred embodiment my be sent in three ways:
1. text in the form of just a “<name>” sent to 222. This causes voice connection to a number associated with the interpreted name. The symbols < > mean substitution of the < > and contents by a literal string.
2. text in the form “<name> . . . <message>”. This causes the text <message> to be sent to a number associated with the interpreted name.
3. text in the form “ . . . <message>”. This causes the text <message> to be sent to the number most recently determined using a Text Dial message, i.e. a type of continuation message.

For example
Text ‘British Airways’ sent to 222 results in a voice call being set up to the airline.
Text ‘British Airways. Arrival time of BA567’ results in ‘Arrival time of BA567’ being sent by text messaging means to British Airways, and no voice call being set up. When British Airways replies, the reply preferably comes from the CLI ‘222’. The network retains the association between 222 and British Airways, so that if the user sends a continuation text message starting with ‘ . . . ’, or makes a voice call to 222, he is automatically connected with the airline.

Alternatively, delimiters as described above may be avoided altogether if one short code is used as the destination number for the text message used to specify the alphanumeric address and a different short code is used as the destination for text messages to be sent to that address or as the destination for requesting an outdialled call set-up. Many other variations are possible.

In a further embodiment of the invention, the Man Machine Interface (MMI) of the mobile telephone is modified to further simplify the process of setting up a voice or audiovisual connection using the invention. For example the user is able to simply enter alpha text and press send. Currently on most mobile handsets one is able to enter numbers directly and then press send to make a telephone call. It is envisaged that in future alpha entry and numeric entry will be alternative, with either selectable as the default.

In an embodiment, speed of call set-up may be improved by making use of the knowledge of the user's location that is carried with the user's text message. This message informs the SMS Router of the address of the MSC/VLR to which the user is connected. The SMS Router may then imitate an HLR, and request a roaming number from this MSC/VLR. If this roaming number is then passed to the Voice Switching equipment, then an outdialled call may be made to the user without further recourse to HLR routing queries.

The system may generate service usage statistics such as information regarding the number of calls to particular services and the text identifiers used to access them. In addition, the system can report all text identifiers for which there is no entry in the database. This will enable the network operator or service provider to determine whether alternative text identifiers need to be added to the database to enable access to existing services, or whether there is a demand for additional services. The SMS Wizard also retains a log of the translations made, and the translations that could not be completed. The log of unsuccessful translations allows the system operator to determine the types of destination that are being requested, and the types of errors that are being made, and allows the SMS Wizard content to be developed using this feedback in a way that matches the users' needs. These facilities enable maximisation of service availability and system usage, with consequent customer satisfaction and revenue generation.

In so far as the embodiment(s) of the invention described above may be implemented, the processing of the alphanumeric entry made by the user may be carried out wholly in the network, or partly in the network and partly in the handset. It is envisaged that handset developments may permit implementations of the invention that split the processing between the handset and the network.

In so far as the embodiment(s) of the invention described above may be implemented, at least in part, using software controlled processing apparatus, it will be appreciated that a computer program providing such software control and a storage medium by which such a computer program is stored are envisaged as aspects of the invention.

1. Telecommunications apparatus comprising a telephone network, a telephone terminal operable to enable a user to specify dialling information in a form that comprises text, means to process the dialling information to identify a associated with the text, the network being adapted to receive an indialled call from the terminal, to set up the connection associated with the text and to connect the indialled call with the connection associated with the text.

2. Apparatus as claimed in claim 1, in which the said means to process the dialling information to identify a connection associated with the text is within the network.

3. Apparatus as claimed in claim 2, in which the terminal is operable to transmit text dialling information to the network.

4. Apparatus as claimed in claim 1, in which the means to process the dialling information to identify a connection associated with the text is partly within the network and partly within the terminal.

5. Apparatus as claimed in claim 4, in which the terminal is operable to transmit partly processed text dialling information to the network.

6. Apparatus as claimed in claim 1, in which transmission of text dialling information occurs before the indialled call, or at least partly in parallel with the indialled call.

7. Apparatus as claimed in claim 1, in which the terminal is a mobile terminal.

8. Apparatus as claimed in claim 1, in which the text dialling information is addressed to a service number.

9. Apparatus as claimed in claim 8, in which the indialled call is addressed to a service number.

10. Apparatus as claimed in claim 9, in which the text dialling information and the indialled call are addressed to the same service number.

11. Apparatus as claimed in claim 8, in which the service number is a short code or international number.

12. Apparatus as claimed in claim 1, in which the text dialling information is transmitted as a text message, such as an SMS, EMS or GPRS text message.

13. Apparatus as claimed in claim 1, in which an acknowledgement is returned to the telephone terminal indicating that the network has processed the text dialling information.

14. Apparatus as claimed in claim 1, in which the text dialling information is processed at least partly in parallel with the indialled call.

15. Apparatus as claimed in claim 1, in which the means to process the dialling information to identify a connection associated with the text is operable to process the text intelligently using a system of exceptions, classes and rules to derive an alphanumeric string from the text.

16. Apparatus as claimed in claim 15, in which the means to process the dialling information is further operable to determine a desired connection based on the derived alphanumeric string.

17. Apparatus as claimed in claim 1, in which the means to process the dialling information to identify a connection associated with the text retains memory of the connection and is operable to make a without re-entry of the text.

18. Apparatus as claimed in claim 1, in which the means to process the dialling information to identify a connection associated with the text is operable to translate between text dialling information and connections that are personalised to a particular individual or closed group of individuals.

19. Apparatus as claimed in claim 1, in which the means to process the dialling information to identify a connection associated with the text is operable to make connections to services and to generate service usage statistics regarding the numbers of calls to particular services and the text dialling information used to identify them.

20. Apparatus as claimed in claim 1, in which the connection associated with the text is characterised as a telephone number.

21. Apparatus as claimed in claim 1, in which the connection associated with the text is characterised without reference to a telephone number.

22. A method of operating telecommunications apparatus comprising a telephone network and a telephone terminal, the method comprising the steps of employing the terminal to enable a user to specify dialling information in a form that comprises text, processing the dialling information to identify a connection associated with the text, indialling a call to the network, setting up the connection associated with the text in response to the indialled call and connecting the indialled call with the connection associated with the text.

23. A method as claimed in claim 22, in which the step of processing the dialling information to identify the connection associated with the text employs means within the network.

24. A method as claimed in claim 23, in which text dialling information is transmitted from the terminal to the network.

25. A method as claimed in claim 22, in which the step of processing the dialling information to identify the connection associated with the text employs means partly within the network and partly within the terminal.

26. A method as claimed in claim 25, in which partly processed text dialling information is transmitted from the terminal to the network.

27. A method as claimed in claim 22, in which transmission of text dialling information occurs before the indialled call, or at least partly in parallel with the indialled call.

28. A method as claimed in claim 22, in which the terminal is a mobile terminal.

29. A method as claimed in claim 22, in which the text dialling information is addressed to a service number.

30. A method as claimed in claim 29, in which the indialled call is addressed to a service number.

31. A method as claimed in claim 30, in which the text dialling information and the indialled call are addressed to the same service number.

32. A method as claimed in claim 29, in which the service number is a short code or international number.

33. A method as claimed in claim 22, in which the text dialling information is transmitted as a text message, such as an SMS, EMS or GPRS text message.

34. A method as claimed in claim 22, in which an acknowledgement is returned to the telephone terminal indicating that the network has processed the text dialling information.

35. A method as claimed in claim 22, in which the text dialling information is processed at least partly in parallel with the indialled call.

36. A method as claimed in claim 22, in which the step of processing the dialling information to identify a connection associated with the text, comprises processing the text intelligently using a system of exceptions, classes and rules to derive an alphanumeric string from the text.

37. A method as claimed in claim 36, in which a desired connection is determined based on the derived alphanumeric string.

38. A method as claimed in claim 22, in which the step of processing the dialling information to identify a connection associated with the text comprises retaining memory of the connection and making a without re-entry of the text.

39. A method as claimed in claim 22, in which dialling information is translated between text dialling information and connections that are personalised to a particular individual or closed group of individuals.

40. A method as claimed in claim 22, in which dialling information is processed to make connections to services and service usage statistics are generated regarding the numbers of calls to particular services and the dialling information used to identify them.

41. A method as claimed in claim 22, in which the connection associated with the text is characterised as a telephone number.

42. A method as claimed in claim 22, in which the connection associated with the text is characterised without reference to a telephone number.

43. A computer program for implementing a method according to claim 22.

44. A storage medium storing a computer program according to claim 43.
